(19) United States
(12) Patent Application Publication
(10) Pub. No.: US 2015/0220895 A1
(43) Pub. Date: Aug. 6, 2015

(54) DISTRIBUTOR BUSINESS TO RETAILER BUSINESS PAYMENT SYSTEM AND METHOD USING MOBILE PHONES

(71) Applicant: GCS INVESTMENTS, LTD., Santo Domingo (DO)

(72) Inventor: Day Jimenez, Miami, FL (US)

(21) Appl. No.: 14/423,072

(22) PCT Filed: Aug. 22, 2013
(86) PCT No.: PCT/US2013/056254

§ 371 Date: Feb. 20, 2015

Related U.S. Application Data
(60) Provisional application No. 61/692,461, filed on Aug. 23, 2012.

(51) Int. Cl. G06Q 20/14; G06Q 20/26; G06Q 20/32; G06Q 20/24

(52) U.S. Cl. CPC G06Q 20/14; G06Q 20/24; G06Q 20/26; G06Q 20/322; G06Q 20/3278

(57) ABSTRACT

A method and system for processing invoice transactions between vendors (distributors) and retailers via mobile phone is disclosed. Each distributor has a unique vendor identifier. Each retailer has a unique identifier, typically his/her mobile phone number. An intermediary system processes payments and upon verification of account balance at retailer's bank, the intermediary system notifies the vendor bank, debits the funding account at the retailer's bank, processes a credit to the vendor's bank, and sends an approval message to the retailer's mobile phone.

### BACKGROUND

1. Field

The present disclosure generally relates to financial transaction systems and methods and more particularly to a computerized system and method for processing bank business financial transactions utilizing mobile phones.

2. Description of Related Art

Several mobile payment initiatives have been implemented in different parts of the world using various mobile payment technologies and methods which mostly require sophisticated handsets (e.g. smart phones), mobile communication components (e.g. Near Field Communication (NFC)) and subscriber identity module (SIM)/chip technologies, with the ability to use wireless application protocol (WAP)/Internet facilities to perform financial transactions and other mobile services in a mobile commerce economy. However, the globalization of these mobile payment solutions is still limited by certain market conditions, cost of compatible mobile devices and services, availability of funding sources, and network/acquirer infrastructure. The convergence of mobile and payment has proven to be a complex undertaking, requiring the association and cooperation of multiple business players and partners. What is needed is a simple, straightforward system and method for utilizing existing mobile phone technology and existing payment processing system capabilities cooperating to facilitate transactions through an intermediary bank between product suppliers/distributors and their retail vendors.

### SUMMARY

The present disclosure utilizes a USSD (Unstructured Supplementary Service Data) capability that exists in current mobile phones to facilitate transaction inquiry and transaction reporting between vendors (suppliers) and their bank to and from merchants (retailers) such that paper money transactions are virtually eliminated thus simplifying the distribution and delivery of goods and transfer of payments for such goods in a more seamless manner.

The present disclosure provides a simple and secure process solution that integrates standard, readily available mobile technologies (e.g., GSM USSD) with business stakeholders (e.g., merchants, banks, etc) to enable business customer payments in a seamless and effective manner through the use of a unique mobile payment system and software application.

An exemplary method of processing a payment to a vendor for an invoice from the vendor to a retailer via a mobile phone in accordance with the present disclosure includes operations of providing a mobile phone to a retailer having stored therein a payer identifier unique to the retailer, entering a vendor's contact number into the retailer's mobile phone, entering a transaction amount into the mobile phone, generating a transaction authorization request message in the retailer's mobile phone, sending the transaction authorization request via an intermediary to the vendor's contact number. Upon receiving confirmation of authorization from the intermediary at the retailer's mobile phone, via the intermediary, a debit request from the funding account of retailer's bank is sent and the funding account is debited. The intermediary sends a credit request to the vendor's account and confirms credit to the vendor's account, and sends a confirmation message to the retailer's mobile phone.

The method may also include operations of sending a MSISDN validation request from the retailer to the intermediary and confirming MSISDN validation at a vendor's connector bank. If confirmed, validation confirmation is returned to the retailer's mobile phone. If not confirmed, an error message is returned to the retailer's mobile phone.

An embodiment of a system in accordance with the present disclosure for processing a payment to a vendor for an invoice from the vendor to a retailer via a retailer's mobile phone may include a computing device having a processor operably connected to a common database and communicatively coupled to a retailer's mobile phone, retailer's bank account and a vendor's bank account. This computing device is preferably programmed to receive from the retailer's mobile phone having stored therein a payer identifier unique to the retailer, a MSISDN, a transaction amount, identity of a vendor, and a transaction authorization request message, and request MSISDN validation from the vendor's bank. If the MSISDN is verified, the computing device is programmed to send the transaction authorization request to the retailer's bank to debit the retailer's account, instruct the retailer's bank to debit the retailer's account, confirm a corresponding credit to the vendor's account, and send a confirmation message to the retailer's mobile phone and to the vendor. If the MSISDN is not verified, the computing device is programmed to send an error message to the retailer's mobile phone.

Further features, advantages and characteristics of the embodiments of this disclosure will be apparent from reading the following detailed description when taken in conjunction with the drawing figures.

### BRIEF DESCRIPTION OF THE DRAWINGS

FIG. 1 illustrates a bank collection concept in accordance with one embodiment of the present disclosure.

FIG. 2 illustrates the step by step process of the bank collection process in accordance with the present disclosure.

FIG. 3 is a process flow diagram showing the direct payment operations in the process in accordance with the present disclosure.

FIG. 4 is a process flow diagram showing the transactional flow operations for pending invoice transactions in accordance with the present disclosure.

FIG. 5 illustrates the sequence of USSD screens that are prompted on the vendor's mobile phone as part of the USSD session to execute a payment transaction.

FIG. 6 illustrates the sequence of USSD screens for payment on a retailer's mobile phone for unregistered invoices.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The end-to-end process in accordance with the present disclosure preferably takes advantage of key mobile and network technologies namely the USSD protocol and network-generated USSD Push feature to provide a special customer experience for exchanging information to facilitate real-time/online payment transactions.

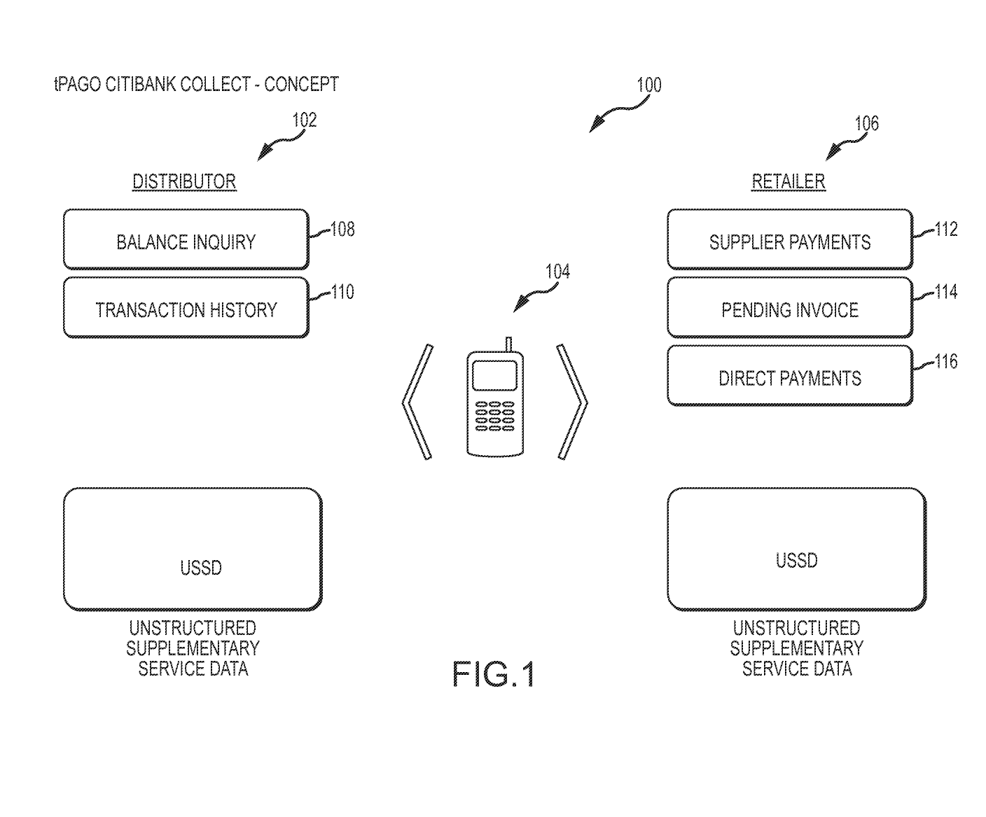

Turning now to the drawings, a concept diagram of the basic bank collect process 100 between a distributor or vendor 102 via mobile phone 104 to and from a retailer merchant 106 is shown in FIG. 1. Specifically, the distributor or vendor 102 may utilize his or her mobile phone 104 to display a balance inquiry 108 or transaction history 110 of his bank account. Similarly, the retailer merchant can view on his or her mobile phone 104 payments made to suppliers, 112, pending invoices 114 and/or direct payments 116 made to distributors 102. Both the distributor and the retailer utilize existing USSD capabilities on their mobile phones in order to perform these functions.

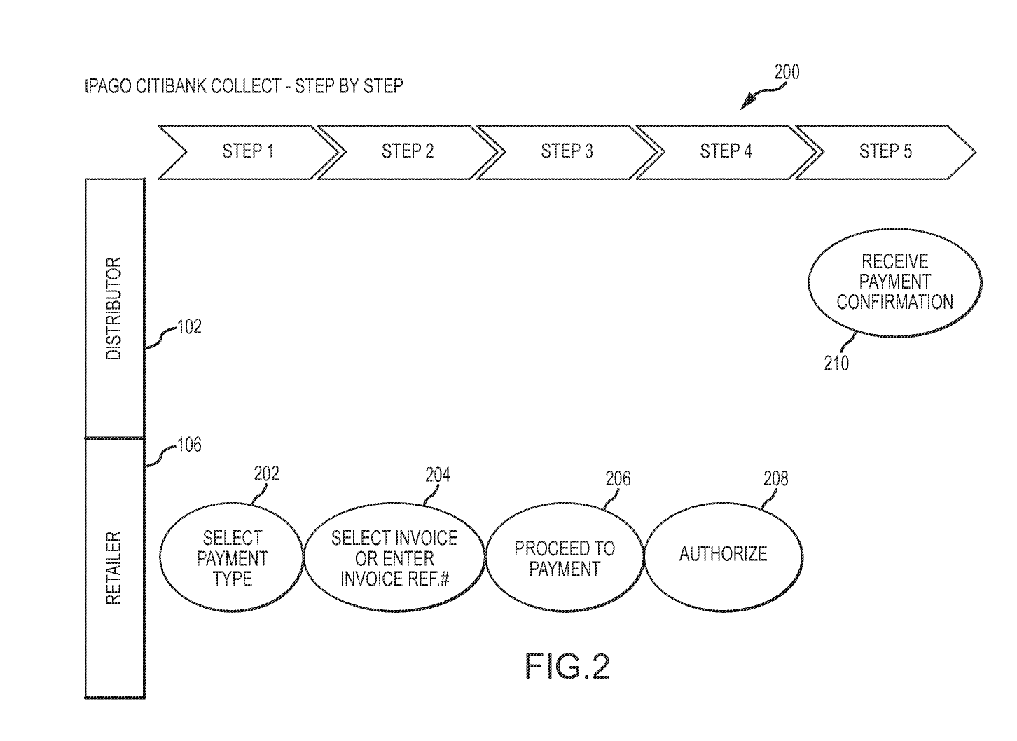

An illustration of the operational process steps 200 involved in a retailer 106 making a payment to a distributor 102 is shown in FIG. 2. On the retailer side, the retailer 106 at step 1 selects the payment type in operation 202. Here the retailer selects the payment source, i.e., whether the payment is to be a debit from his/her cash account or from a different source.

Control then transfers to step 2. In step 2 the retailer selects a displayed invoice in operation 204 or enters an invoice reference number if the desired invoice is not displayed. Control then transfers to step 3. Here in operation 206, the invoice payment proceeds through the system. Control then transfers to step 4 where the particular invoice payment is authorized in operation 208 by the retailer's bank, and the fund amount is transferred to the appropriate distributor account. Control then transfers to operation 210 in step 5 where the distributor is sent a confirmation message. This confirmation may be transmitted directly for display on the distributor's mobile phone 104 or stored for later retrieval and display as desired by the distributor.

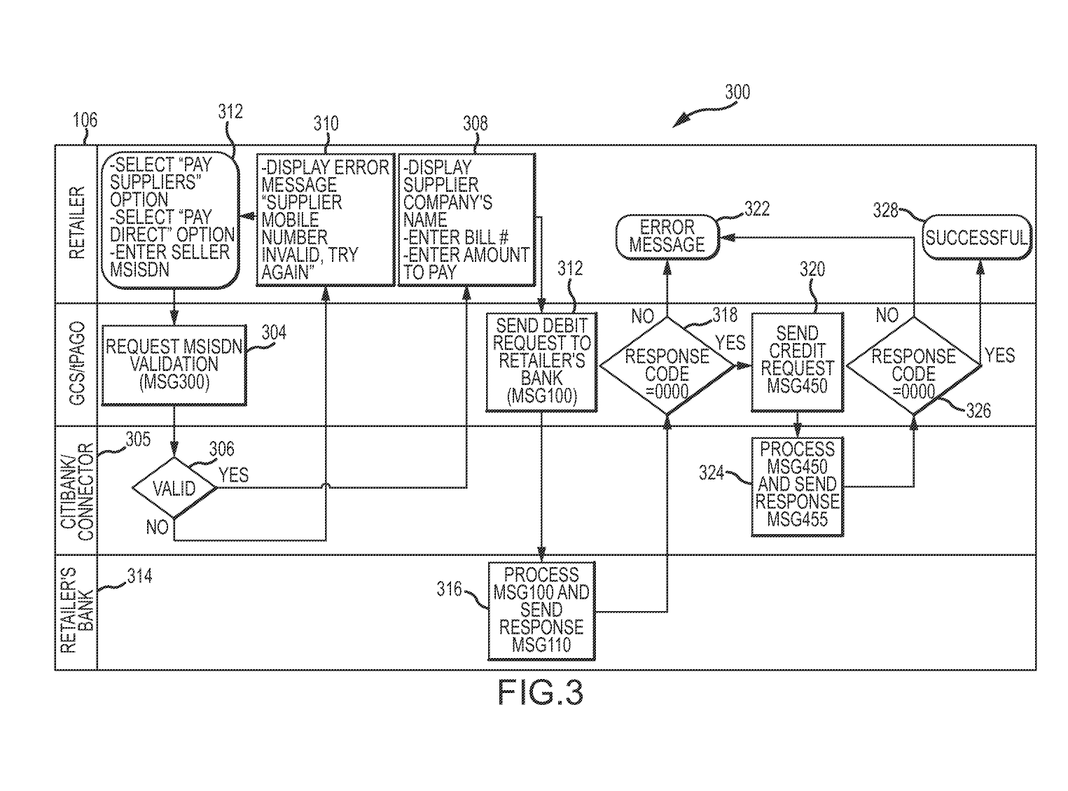

An exemplary process flow diagram of the operations 300 involved in an exemplary direct payment to suppliers, i.e. vendors, is shown in FIG. 3. This process begins in operation 302. Here the retailer selects a “Pay Suppliers” option on his mobile phone, and then selects a “Pay Direct option. The mobile phone 104 then prompts the retailer to enter the appropriate MSISDN (Mobile Station International Subscriber Directory Number) for the particular vendor the retailer wishes to pay. Control then tranfers to an intermediary interface 303 in operation 304 (e.g. CGS/tPago) where the MSISDN validation is requested from the bank connector 305. Control then transfers to the bank/connector query operation 306. The connector query operation 306 makes a determination, typically from a connected funding bank, whether the retailer requested MSISDN is or is not valid. If the MSISDN is valid, control transfers back to the retailer's mobile phone and displays the supplier's name in operation 308. Also in operation 308, the retailer is requested to enter on his or her mobile phone the invoice (bill) number and an amount to pay.

On the other hand, if, in operation 306, it is determined that the MSISDN provided by the retailer in operation 302 is invalid, control transfers to operation 310. In operation 310, an error message is displayed on the retailer's mobile phone. One typical message could be “Supplier mobile phone number invalid—Try again.”

When a successful MSISDN has been entered and validated, and a bill # and amount to pay entered in operation 308 by the retailer, control transfers to operation 312. In operation 312, the intermediary handling interface (GCS/tPago) 303 sends a debit request to the retailer's bank 314 and transfers control to operation 316. In operation 316, the bank 314 processes the debit request in operation 316, i.e. determines whether the retailer has in fact the funds necessary to pay the amount requested in operation 308. If so the response is a predetermined code such as 0000. The code 0000 is transferred back to the intermediary handling interface 303 to query operation 318.

Query operation 318 determines whether the proper code has been received from the bank 314. If the proper code 0000 has been received, control transfers to operation 320. On the other hand, if the response code received in query operation 318 is not proper, control transfers to operation 322 where an error message is provided to the retailer. This error message will most likely indicate that there is insufficient funds in the funding account.

If, in operation 318, the proper code was received, and control transferred to operation 320, the operation 320 sends a credit request message to the distributor connector bank 305 in operation 324. In return, the connector bank sends a response code back to the intermediary GCS/tPago query operation 326.

Query operation 326 determines whether the proper response code has been received. If not, control transfers again to operation 322 where an error message is generated to the retailer. If the proper response has been received in query operation 326, a successful transaction message is conveyed to the retailer in operation 328 to complete the process.

As can readily be seen from FIG. 3, the activity by the connector bank 305 is minimal. Most of the processing activity takes place by the GCS/tPago intermediary 303 thus relieving the collector bank and the retailer's bank of significant processing activity.

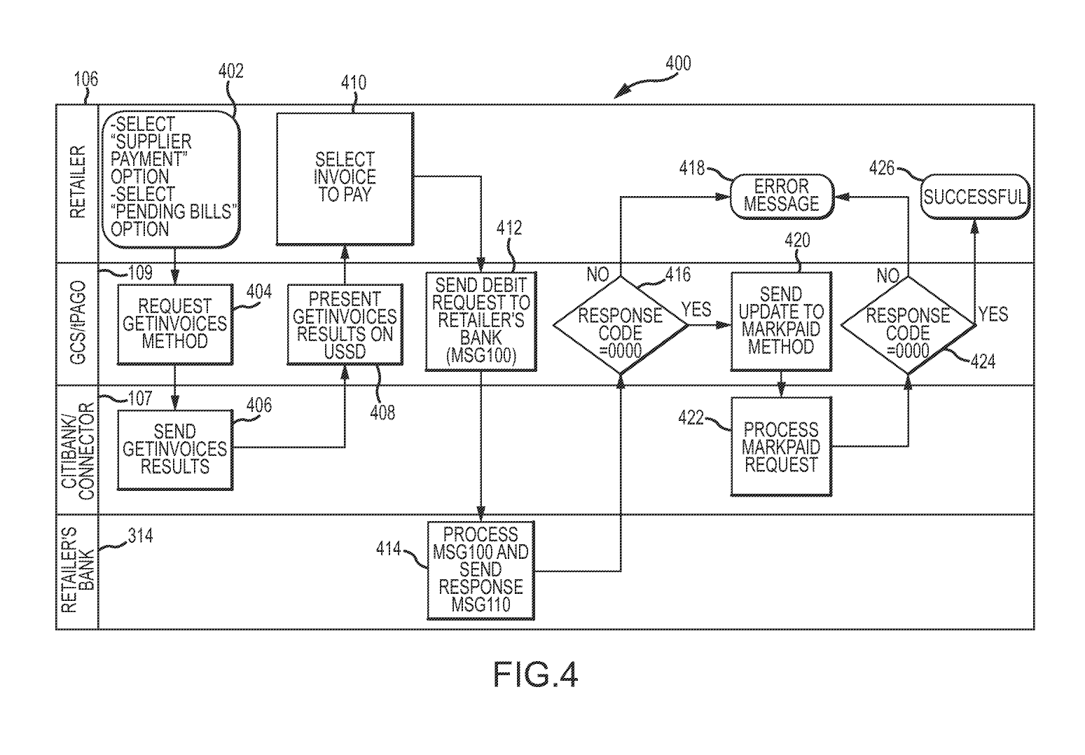

A transactional process flow diagram for pending invoices is shown in FIG. 4. Again, the four entities involved are the retailer 106, the retailer's bank 314, the vendor's bank/connector 107, and a GCS/tPago intermediary 109. For pending invoices, the transactional flow 400 begins with the retailer in operation 402. In operation 402, the retailer selects “Supplier Payment” option on mobile phone 104. He/she then selects “Pending Bills” on the mobile phone 104. Control then transfers to operation 404.

In operation 404, the intermediary 109 issues a request to get invoices from the vendor's bank connector 107. Control then transfers to operation 406 where the connector bank 107 gathers the invoices that are pending and sends them to the intermediary 109. Control then transfers to operation 408.

In operation 408, the pending invoices are presented to the retailer on his/her mobile phone 104. Control then transfers to the retailer 106. In operation 410, the retailer then chooses which invoice to pay in the present transaction. When an invoice is selected, a debit request is sent to the retailer's bank in operation 412. Control then transfers to operation 414 at the retailer's bank 314. In operation 414 the retailer's bank 314 determines whether sufficient funds are available to pay the invoice, and sends a response code to query operation 416 in the intermediary 109. Control then transfers to query operation 416.

In query operation 416, the question is asked whether the response code received indicates sufficient funds are available, I.e., is it =0000?, for example. If the Response code=0000, then control transfers to operation 420. If the Response code is not=0000, then control transfers to operation 418 where an error message is displayed to the retailer 106 on his mobile phone 104, and the process terminates.

If, in operation 416, the Response code=0000, and control transfers to operation 420, then in operation 420 an update request to the vendor's bank connector 107 is sent to mark the invoice as paid, and credit the appropriate amount to the connector bank account for the vendor, and issue an appropriate Response code again. Control then transfers back to the intermediary 109 to query operation 424. In query operation 424, the question is asked whether the proper Response code has been received from the connector bank 107, e.g.,=0000. If so, control transfers to operation 426 where a successful transaction message is conveyed to the retailer 106 via his/her mobile phone 104. On the other hand, if the Response code received in query operation 424 was not the right one, then control transfers again to operation 418 where another error message is displayed to the retailer 106 on his or her mobile phone 104.

Again, as in FIG. 3, it can be seen that most of the processing activity takes place in the intermediary 109 rather than in either the connector or vendor's bank 107 or the retailer's bank 314. The use of the intermediary 109 thus frees resources of the vendor and retailer's banks

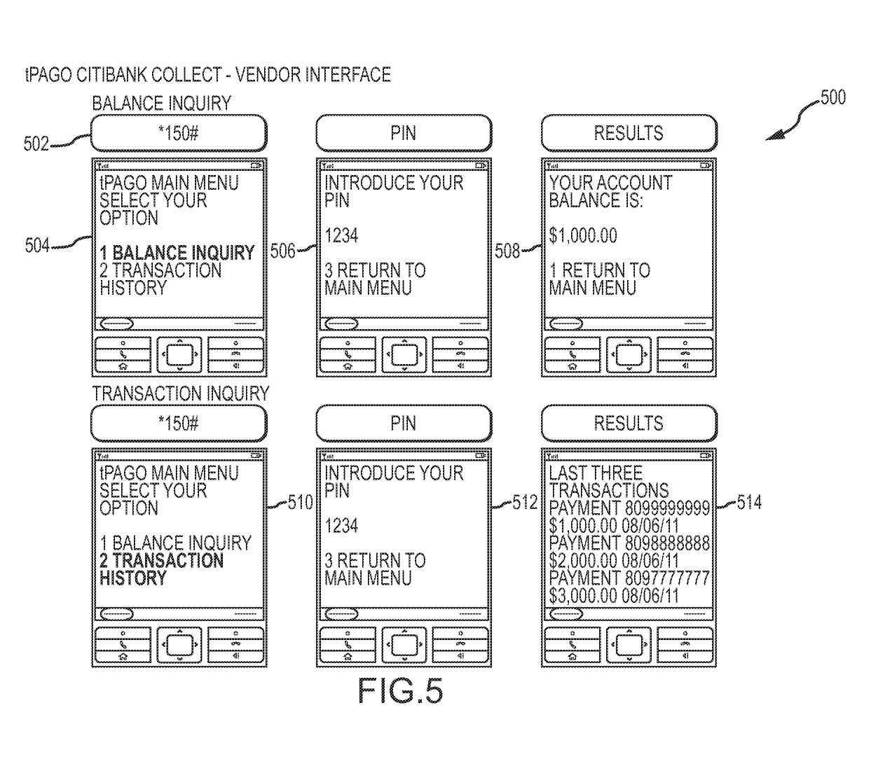

FIG. 5 illustrates exemplary screens on the vendor's mobile phone device 104 during both a balance inquiry and a transaction inquiry. When a vendor enters a predetermined code on the mobile device 104 the intermediary main menu appears. In FIG. 5, an exemplary code of *150# is shown for illustrative purposes only. When this code is entered, the tPago intermediary main screen appears on the vendor's mobile phone, screen shot 504, providing the vendor with two options: Balance Inquiry and Transaction History. If the vendor selects Balance Inquiry, then the screen asks for the vendor's personal identification number (PIN) in screen shot 506. When the proper PIN is entered on screen shot 506, the balance is shown in screen shot 508.

Alternatively, if the vendor selects Transaction History, as shown in screen shot 510, the system again asks for the vendor's PIN in screen shot 512. When the proper PIN is entered, the system displays the last three transactions as shown in screen shot 514.

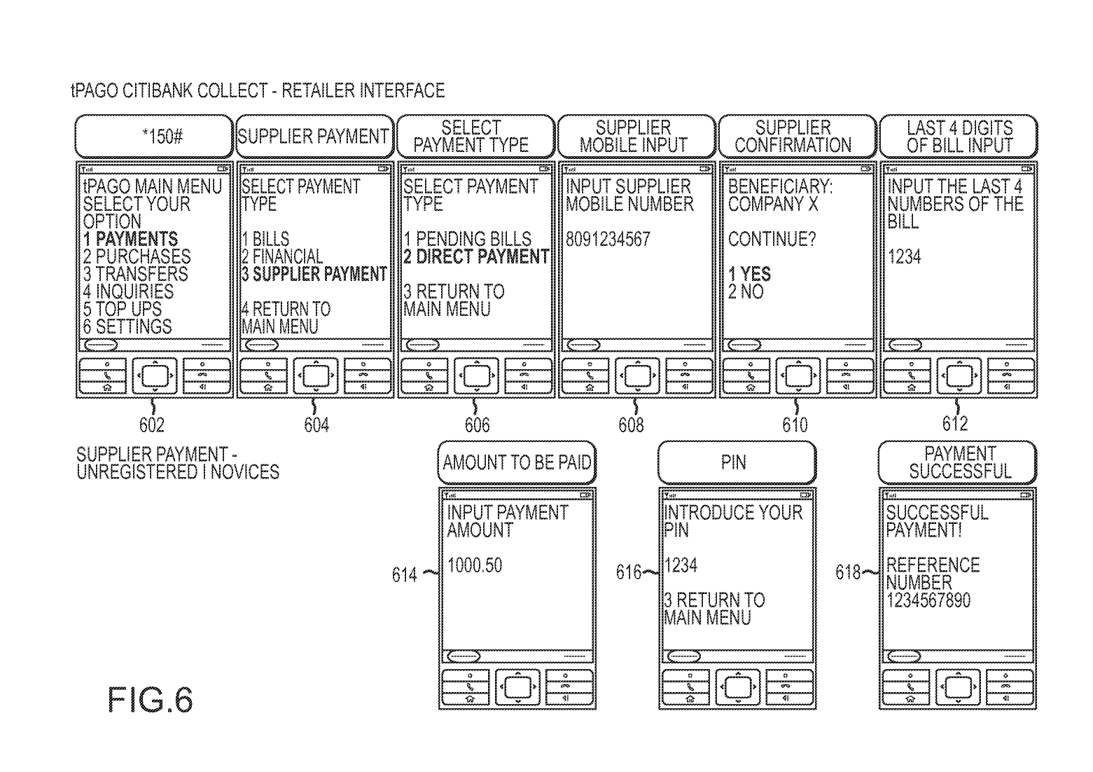

The retailer interface 600 is shown in FIG. 6. As with the vendor interface 500, a main menu 602 is shown when the retailer 106 enters the proper code *150#. This main menu gives you a number of options for display. When the retailer selects Payments, the interface 600 displays a selection of payment types in screenshot 604. If the Supplier Payment selection is made, a further selection is shown regarding Pending Bills and Direct Payments in screen shot 606. Choosing Direct Payment displays a screen 608 which requests the supplier mobile phone number. Upon entry of the supplier's mobile phone number, a confirmation screen 610 is shown so that the retailer can verify whether or not the correct company has been shown. If so, a screen 612 is shown asking for the last four numbers of the bill or invoice. When the correct bill number is entered, a screen 614 is shown asking for the payment amount to be made. Once an amount is entered, the PIN of the retailer is requested in screen shot 616. When the correct PIN is entered, the payment is processed, and, if successful, a successful payment is indicated in screen shot 618 along with a reference number for the transaction.

It is clear that many modifications and variations of this embodiment may be made by one skilled in the art without departing from the spirit of the novel art of this disclosure. In particular, in addition to electronic communication means such as email, SMS, IM, etc., messages may also be exchanged by means of a voice XML or IVR system or other, similar automated voice telephone system. In other cases, other suitable, similar messaging media or web interfaces may be offered for interaction with the system to achieve an exchange of information. These variations do not depart from the broader spirit and scope of the invention, and the examples cited here are to be regarded in an illustrative rather than a restrictive sense.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

It is clear that many modifications and variations of this exemplary embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A method of processing a payment to a vendor for an invoice from the vendor to a retailer via a mobile phone, the method comprising:
providing a mobile phone to a retailer having stored therein a payer identifier unique to the retailer;
entering a vendor's contact number into the retailer's mobile phone;
entering a transaction amount into the mobile phone;
generating a transaction authorization request message in retailer's mobile phone;
sending the transaction authorization request via an intermediary to the vendor's contact number;
receiving confirmation of authorization from the intermediary at the retailer's mobile phone;
sending via the intermediary a debit request from the funding account of retailer's bank;
debiting the funding account;
sending a credit request to the vendor's account via the intermediary;
the intermediary confirming credit to the vendor's account credit; and
sending via the intermediary a confirmation message to the retailer's mobile phone.

2. The method according to claim 1 further comprising sending a MSISDN validation request from the retailer to the intermediary; and
confirming MSISDN validation at a vendor's connector bank;
if confirmed, returning validation confirmation to the retailer's mobile phone;
if not confirmed, returning an error message to the retailer's mobile phone.

3. A system for processing a payment to a vendor for an invoice from the vendor to a retailer via a mobile phone comprising:
a mobile phone provided to a retailer having stored therein a payer identifier unique to the retailer;
means for entering a vendor's contact number into the retailer's mobile phone;
means for entering a transaction amount into the mobile phone;
means for generating a transaction authorization request message in retailer's mobile phone;
means for sending the transaction authorization request via an intermediary to the vendor's contact number;
means for receiving confirmation of authorization from the intermediary at the retailer's mobile phone;
means for sending via the intermediary a debit request from the funding account of retailer's bank;
means for debiting the funding account;
means for sending a credit request to the vendor's account via the intermediary;
means for confirming via the intermediary credit to the vendor's account credit; and
means for sending via the intermediary a confirmation message to the retailer's mobile phone.

4. A system for processing a payment to a vendor for an invoice from the vendor to a retailer via a retailer's mobile phone, the system comprising:
a computing device having a processor operably connected to a common database and communicatively coupled to a retailer's mobile phone, retailer's bank account and a vendor's bank account, wherein the computing device is programmed to:
receive from the retailer's mobile phone having stored therein a payer identifier unique to the retailer, a MSISDN, a transaction amount, identity of a vendor, and a transaction authorization request message;
request MSISDN validation from the vendor's bank;
if the MSISDN is verified, send the transaction authorization request to the retailer's bank to debit the retailer's account;
instruct the retailer's bank to debit the retailer's account;
confirm a corresponding credit to the vendor's account; and
send a confirmation message to the retailer's mobile phone and to the vendor; and
if the MSISDN is not verified, send an error message to the retailer's mobile phone.
